(19) United States
(12) Patent Application Publication
(10) Pub. No.: US 2025/0136894 A1
(43) Pub. Date: May 1, 2025

(54) LAUNDRY EMULSIFIER WITH SURFACTANT AND SOLVENT

(71) Applicant: ECOLAB USA INC., Saint Paul, MN (US)

(72) Inventor: Wei Wang, SHANGHAI (CN)

(21) Appl. No.: 18/837,101

(22) PCT Filed: Mar. 24, 2022
(86) PCT No.: PCT/CN2022/082649

§ 371 Date: Aug. 8, 2024

(51) Int. Cl. C11D 1/72; C11D 3/00; C11D 3/20; C11D 3/43; D06L 1/12

(52) U.S. Cl. CPC C11D 1/721; C11D 3/0026; C11D 3/2068; C11D 3/43; D06L 1/12

(57) ABSTRACT

Disclosed herein are laundry emulsifier compositions comprising one or more ethoxylated alcohol surfactants and one or more organic solvents, along with methods of using the compositions to remove stubborn soils, particularly oily or greasy soils. The compositions disclosed herein are particularly useful at removing oily or greasy soils from textiles comprising synthetic fibers such as polyester or blends of polyester. Also disclosed herein are compositions and methods of using the same which are cost-effective to make and use.

### TECHNICAL FIELD

The present disclosure relates to laundry emulsifier compositions comprising one or more branched ethoxylated fatty alcohol surfactants and one or more organic solvents and methods of making the same. In particular, the disclosure relates to emulsifier compositions comprising two different branched ethoxylated fatty alcohol nonionic surfactants together with an alcohol organic solvent and a propylene organic solvent. The disclosure also relates generally to the field of soil removal from textiles, particularly greasy and oily soils.

### TECHNICAL BACKGROUND

Oily and greasy soils are particularly challenging to remove from washable textiles, particularly those comprised of synthetic materials such as polyester or blends of polyester. Oily soils can diffuse deeply into the textile and spread in a wicking pattern along textile fibers. Oily and greasy particles also bind together with other dust and soil particles to form greasy stain composites adhered to the textile.

Further, the time lag between soiling and washing in industrial or commercial settings often permits the soiled fabric to lie unwashed for a period of time such that the soil diffuses inside the textile fibers. This time lag permits the greasy soil more time to diffuse into the textile and attract other dirt and dust. Cleaning such complex organic or greasy soils from such woven or non-woven fabrics has been a challenge for cleaning processes for many years.

Existing greasy soil remover compositions suffer from a variety of deficiencies. For example, many aqueous cleaning compositions are unable to provide substantial cleaning capacity when faced with heavy deposits of complex organic or inorganic soils embedded deep in textiles. Solvent-based detergents typically utilize very high concentrations of inorganic solvents to remove complex soils by dissolving the organic soil in a large proportion of solvent. Such compositions can damage the textile, can be dangerous due to solvent flammability, can involve exposure to toxic substances, and can be expensive or time-consuming. Further, while soil-removing enzymes and polymers can increase detergent efficacy, such components are often cost-ineffective, can reduce the quality of the textile (e.g., by deposition of active agent on the surface of the textile, yellowing, or softness reduction), and can reduce the overall life of the cleaned textile.

Thus, there exists a need for detergent compositions that provide effective soil removal efficacy of stubborn soils.

More particularly, there is a need for detergent compositions that provide effective soil removal efficacy of oily or greasy soils.

There is also a need to develop detergent compositions that provide a cost-effective method of removing stubborn soils.

These and other objects, advantages, and features of the present disclosure will become apparent from the following specification taken in conjunction with the claims set forth herein.

### BRIEF SUMMARY

An advantage of the methods and compositions disclosed herein is that they are effective at removing soils from textiles, particularly greasy or oily soils through contacting the textiles with a laundry detergent emulsifier. It is an advantage that the laundry detergent emulsifier compositions disclosed herein are cost-effective solvent-based emulsifications that do not rely on very high concentrations of solvents or inorganic solvents to remove oily soils from textiles.

Disclosed herein are textile cleaning compositions comprising: a first alcohol ethoxylate having between 7 moles of ethylene oxide and 10 moles of ethylene oxide; a second alcohol ethoxylate having between 3 moles of ethylene oxide and 7 moles of ethylene oxide; a glycol solvent; and an alcohol solvent.

In an embodiment, the first alcohol ethoxylate is a compound according to the formula:

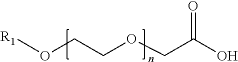

wherein R₁ is a linear or branched, saturated or unsaturated, substituted or unsubstituted alkyl group with a chain length of between 2 and 20; and wherein n is an integer between 7 and 10; and the second alcohol ethoxylate is a compound according to the formula:

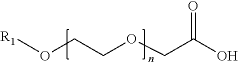

wherein R₁ is a linear or branched, saturated or unsaturated, substituted or unsubstituted alkyl group with a chain length of between 2 and 20; and wherein n is an integer between 3 and 6.

In an embodiment, the alkyl group of the first alcohol ethoxylate has a chain length of between 10 and 15 and the alkyl group of the second alcohol ethoxylate has a chain length of between 10 and 15. In a further embodiment, the first alcohol ethoxylate has a chain length of between 12 and 13, and the alkyl group of the second alcohol ethoxylate has a chain length of between 12 and 13.

According to an embodiment, the glycol solvent is an ethylene glycol solvent, a propylene glycol solvent, or a combination thereof. In an embodiment, the alcohol solvent is ethanol, butanol, benzyl alcohol, isopropyl alcohol, or a combination thereof. In a preferred embodiment, the glycol solvent is propylene glycol, and the alcohol solvent is isopropyl alcohol.

In an embodiment, the compositions further comprise a defoaming agent according to the formula:

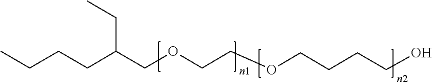

wherein n₁ is an integer of between 1-2 and n₂ is an integer of between 1-2. According to some embodiments, the defoaming agent is present in an amount of from about 1 wt. % to about 10 wt. %.

According to some embodiments, the textile cleaning composition comprises between about 20 wt. % to about 50 wt,% of the first alcohol ethoxylate, from about 10 wt. % to about 30 wt,% of the second alcohol ethoxylate, from about 5 wt. % to about 15 wt. % of the alcohol solvent, and from about 5 wt. % to about 15 wt. % of the glycol solvent.

Also disclosed herein are methods of cleaning a textile comprising: contacting the textile with a textile cleaning composition comprising a first alcohol ethoxylate having between 7 moles of ethylene oxide and 10 moles of ethylene oxide; a second alcohol ethoxylate having between 3 moles of ethylene oxide and 7 moles of ethylene oxide; a glycol solvent; and an alcohol solvent; and removing a soil from the textile.

In an embodiment, the first alcohol ethoxylate is a compound according to the formula:

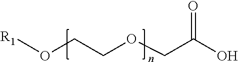

wherein R₁ is a linear or branched, saturated or unsaturated, substituted or unsubstituted alkyl group with a chain length of between 2 and 20; and wherein n is an integer between 7 and 10; and the second alcohol ethoxylate is a compound according to the formula:

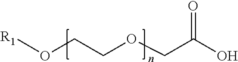

wherein R₁ is a linear or branched, saturated or unsaturated, substituted or unsubstituted alkyl group with a chain length of between 2 and 20; and wherein n is an integer between 3 and 6.

In an embodiment, the alkyl group of the first alcohol ethoxylate has a chain length of between 10 and 15 and the alkyl group of the second alcohol ethoxylate has a chain length of between 10 and 15. In a further embodiment, the first alcohol ethoxylate has a chain length of between 12 and 13, and the alkyl group of the second alcohol ethoxylate has a chain length of between 12 and 13.

According to an embodiment, the glycol solvent is an ethylene glycol solvent, a propylene glycol solvent, or a combination thereof. In an embodiment, the alcohol solvent is ethanol, butanol, benzyl alcohol, isopropyl alcohol, or a combination thereof. In a preferred embodiment, the glycol solvent is propylene glycol, and the alcohol solvent is isopropyl alcohol.

In an embodiment, the compositions further comprise a defoaming agent according to the formula:

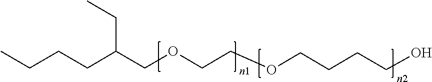

wherein n₁ is an integer of between 1-2 and n₂ is an integer of between 1-2. According to some embodiments, the defoaming agent is present in an amount of from about 1 wt. % to about 10 wt. %.

According to some embodiments, the textile cleaning composition comprises between about 20 wt. % to about 50 wt,% of the first alcohol ethoxylate, from about 10 wt. % to about 30 wt. % of the second alcohol ethoxylate, from about 5 wt. % to about 15 wt. % of the alcohol solvent, and from about 5 wt. % to about 15 wt. % of the glycol solvent.

In an embodiment, the wash cycle comprises a pre-soak phase, a wash phase, a rinsing phase, a finishing phase, and an extraction phase. In a further embodiment, the composition is applied to the textile during any phase of the wash cycle, preferably during the pre-soak phase or the wash phase.

In an embodiment, the soil is a greasy or oily soil.

In a further embodiment, the textile is comprised of cotton, polyester, or a cotton/polyester blend.

While multiple embodiments are disclosed, still other embodiments of the present disclosure will become apparent based on the detailed description, which shows and describes illustrative embodiments of the disclosure. The forgoing summary is illustrative only and is not intended to be in any way limiting. In addition to the illustrative aspects, embodiments, and features described above, further aspects, embodiments, and features of the present technology are apparent from the following drawings and the detailed description, which shows and describes illustrative embodiments of the present technology. Each feature of the technology described herein may be combined with any one or more other features of the disclosure, e.g., the methods may be used with any composition described herein. Accordingly, the drawings and detailed description are to be regarded as illustrative and not restrictive.

### BRIEF DESCRIPTION OF THE DRAWINGS

FIG. 1 shows the results of a soil removal test evaluating the soil removal capabilities of the compositions described herein on a variety of textiles and a variety of soils.

FIG. 2 shows the soil removal efficacy of branched alcohol ethoxylates compared to linear alcohol ethoxylates.

FIG. 3 shows the soil removal efficacy of combinations of branched alcohol ethoxylates.

FIG. 4 shows the soil removal efficacy of combinations of branched alcohol ethoxylates at varying ratios of each of the alcohol ethoxylates.

FIG. 5 shows the soil removal efficacy of compositions comprising different organic solvents.

Various embodiments of the present disclosure will be described in detail regarding the drawings. Reference to various embodiments does not limit the scope of the disclosure. Figures represented herein are not limitations to the various embodiments according to the disclosure and are presented for exemplary illustration of the disclosure.

### DETAILED DESCRIPTION OF THE PREFERRED EMBODIMENTS

The present disclosure relates to methods and compositions effective at removing soils from textiles, particularly greasy or oily soils through contacting the textiles with a laundry detergent emulsifier. It is an advantage that the laundry detergent emulsifier compositions disclosed herein are cost-effective solvent-based emulsifications that do not rely on very high concentrations of solvents or inorganic solvents to remove oily soils from textiles.

The embodiments of this disclosure are not limited to particular types of compositions or methods, which can vary. It is further to be understood that all terminology used herein is to describe particular embodiments only and is not intended to be limiting in any manner or scope. For example, as used in this specification and the appended claims, the singular forms “a,” “an” and “the” can include plural referents unless the content indicates otherwise. Unless indicated otherwise, “or” can mean any one alone or any combination thereof, e.g., “A, B, or C” means the same as any of A alone, B alone, C alone, “A and B,” “A and C,” “B and C” or “A, B, and C.” Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 1%1, and 4% This applies regardless of the breadth of the range.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The terms “a,” “an,” and “the” include both singular and plural referents.

The term “or” is synonymous with “and/or” and means any one member or combination of members of a particular list.

The term “about,” as used herein, refers to variation in the numerical quantity that can occur, for example, through typical measuring techniques and equipment, with respect to any quantifiable variable, including, but not limited to, mass, volume, time, temperature, pH, reflectance, whiteness, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “actives” or “percent actives” or “percent by weight actives” or “actives concentration” are used interchangeably herein and refer to the concentration of those ingredients involved in cleaning expressed as a percentage minus inert ingredients such as water or salts.

The term “laundry” refers to items or articles that are cleaned in a washing machine. In general, laundry refers to any item or article made from or including textiles such as woven fabrics, non-woven fabrics, and knitted fabrics. Frequently, the textile materials contain cotton fibers. The textile materials can comprise natural or synthetic fibers. Further, the textile materials can comprise additional non-cotton fibers such as silk fibers, linen fibers, polyester fibers, polyamide fibers including nylon, acrylic fibers, acetate fibers, and blends thereof including, but not limited to, cotton and polyester blends. The fibers can be treated or untreated. It should be understood that the term “linen” is often used to describe certain types of laundry items including bed sheets, pillowcases, towels, table linen, tablecloth, bar mops, and uniforms.

As used herein, a solid cleaning composition refers to a cleaning composition in the form of a solid such as a powder, a particle, an agglomerate, a flake, a granule, a pellet, a tablet, a lozenge, a puck, a briquette, a brick, a solid block, a unit dose, or another solid form known to those of skill in the art. The term “solid” refers to the state of the cleaning composition under the expected conditions of storage and use of the solid cleaning composition. In general, it is expected that the cleaning composition will remain in solid form when exposed to temperatures of up to about 100° F. and greater than about 120° F. A cast, pressed or extruded “solid” may take any form including a block. When referring to a cast, pressed, or extruded solid it is meant that the hardened composition will not flow perceptibly and will substantially retain its shape under moderate stress or pressure or mere gravity, such as for example, the shape of a mold when removed from the mold, the shape of an article as formed upon extrusion from an extruder, and the like. The degree of hardness of the solid cast composition can range from that of a fused solid block, which is relatively dense and hard, for example, like concrete, to a consistency characterized as being malleable and sponge-like, similar to caulking material. In embodiments of the disclosure, the solid compositions can be further diluted to prepare a use solution or added directly to a cleaning application, including, for example, a laundry machine.

As used herein, the term “substantially free” refers to compositions completely lacking the component or having such a small amount of the component that the component does not affect the performance of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

As used herein, the term “soil” refers to polar or non-polar organic or inorganic substances including, but not limited to carbohydrates, proteins, fats, oils, and the like which may or may not contain particulate matter such as mineral clays, sand, natural mineral matter, carbon black, graphite, kaolin, environmental dust, colorant, dyes, polymers, and oils. These substances may be present in their organic state or complexed to a metal to form an inorganic complex. The terms “soil” and “stain” include, but are not limited to, oil-based stains.

As used herein, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to carbon(s) or hydrogen(s) atoms replaced by one or more bonds, including double or triple bonds, to a heteroatom. Thus, a substituted group is substituted with one or more substituents, unless otherwise specified. A substituted group can be substituted with 1, 2, 3, 4, 5, or 6 substituents.

Substituted ring groups include rings and ring systems in which a bond to a hydrogen atom is replaced with a bond to a carbon atom. Therefore, substituted cycloalkyl, aryl, heterocyclic, and heteroaryl groups may also be substituted with substituted or unsubstituted alkyl, alkenyl, and alkynyl groups are defined herein.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having two to about 30 carbon atoms, and further including at least one double bond. In sone embodiments, an alkenyl group has from 2 to about 30 carbon atoms, or typically, from 2 to 10 carbon atoms. Alkenyl groups may be substituted or unsubstituted. For a double bond in an alkenyl group, the configuration for the double bond can be a trans or cis configuration. Alkenyl groups may be substituted similarly to alkyl groups.

Alkynyl groups are straight chain, branched, or cyclic alkyl groups having two to about 30 carbon atoms, and further including at least one triple bond. In some embodiments, an alkynyl group has from 2 to about 30 carbon atoms, or typically, from 2 to 10 carbon atoms. Alkynyl groups may be substituted or unsubstituted, Alkynyl groups may be substituted similarly to alkyl or alkenyl groups.

As used herein, the terms “alkylene”, “cycloalkylene”, “alkynylides”, and “alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

The term “ester” as used herein refers to —R¹COOR² group. R j is absent, a substituted or unsubstituted alkylene, cycloalkylene, alkenylene, alkynylene, arylene, aralkylene, heterocyclylalkylene, or heterocyclylene group as defined herein, R³¹ is a substituted or unsubstituted alkyl, cycloalkyl, alkenyl, alkynyl, aryl, aralkyl, heterocyclylalkyl, or heterocyclyl group as defined herein.

The term “amine” (or “amino”) as used herein refers to —R¹NR²R³ groups. R¹ is absent, a substituted or unsubstituted alkylene, cycloalkylene, alkenylene, alkynylene, arylene, aralkylene, heterocyclylalkylene, or heterocyclylene group as defined herein. R² and R³ are independently hydrogen, or a substituted or unsubstituted alkyl, cycloalkyl, alkenyl, alkynyl, aryl, aralkyl, heterocyclylalkyl, or heterocyclyl group as defined herein.

The term “amine” as used herein also refers to an independent compound. When an amine is a compound, it can be represented by a formula of R^{1′}NR^{2′}R^{3′} groups, wherein R^{1′}. R^{2′}, and R^{3′} are independently hydrogen, or a substituted or unsubstituted alkyl, cycloalkyl, alkenyl, alkynyl, aryl, aralkyl, heterocyclylalkyl, or heterocyclyl group as defined herein.

The term “alcohol” as used herein refers to —ROH groups. R is absent, a substituted or unsubstituted alkylene, cycloalkylene, alkenylene, alkynylene, arylene, aralkylene, heterocyclylalkylene, or heterocyclylene group as defined herein.

The term “carboxylic acid” as used herein refers to —RCOOH groups. R is absent, a substituted or unsubstituted alkylene, cycloalkylene, alkenylene, alkynylene, arylene, aralkylene, heterocyclylalkylene, or heterocyclylene group as defined herein.

The methods, systems, apparatuses, and compositions disclosed herein may comprise, consist essentially of, or consist of the components and ingredients described herein as well as other ingredients not described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

The “scope” of the present disclosure is defined by the claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art.

### Compositions

Exemplary ranges of the compositions are shown in Table 1 below in weight percentage of the solid or liquid compositions, including both concentrate and ready-to-use compositions.

TABLE 1

| | First | Second | Third | Fourth |
|---|---|---|---|---|
| | Exemplary | Exemplary | Exemplary | Exemplary |
| | Range | Range | Range | Range |
| Material | wt. % | wt. % | wt. % | wt. % |
| Branched C10-C16 | 10-90 | 20-80 | 30-70 | 40-60 |
| Alcohol | | | | |
| Ethoxylate (5EO-10EO) | | | | |
| Organic Solvent | 5-50 | 10-40 | 15-45 | 15-35 |
| Additional Functional | 0-30 | 0-20 | 1-15 | 1-10 |
| Ingredients | | | | |

Further example ranges of the compositions are shown in Table 1 below. These compositions are provided in weight percentage of the solid or liquid compositions.

TABLE 2

| | First | Second | Third | Fourth |
|---|---|---|---|---|
| | Exemplary | Exemplary | Exemplary | Exemplary |
| | Range | Range | Range | Range |
| Material | wt. % | wt. % | wt. % | wt. % |
| Branched C10-C16 | 10-50 | 15-45 | 20-40 | 25-35 |
| Alcohol | | | | |
| Ethoxylate (8EO-10EO) | | | | |
| Branched C10-C16 | 1-50 | 5-40 | 10-30 | 15-25 |
| Alcohol | | | | |
| Ethoxylate (3EO-6BO) | | | | |
| First Organic Solvent | 1-40 | 1-25 | 5-15 | 5-10 |
| Second Organic Solvent | 1-40 | 1-25 | 5-15 | 5-10 |
| Additional Functional | 0-30 | 0-20 | 1-15 | 1-10 |
| Ingredients | | | | |

The compositions can be provided in liquid, solid, paste, or gel forms used as part of a prewash, main wash, souring step, or other step(s). The liquid compositions may be diluted to form use compositions, as well as ready-to-use compositions. In general, a concentrate refers to a composition that is intended to be diluted with water to provide a use solution that contacts an object to provide the desired cleaning, rinsing, or the like. The cleaning composition that contacts the articles to be washed can be referred to as a concentrate or a use composition (or use solution) dependent upon the formulation employed in methods. It should be understood that the concentration of the cationic amine compound and other components will vary depending on whether the cleaning composition is provided as a concentrate or as a use solution.

A use solution may be prepared from the concentrate by diluting the concentrate with water or other diluents at a dilution ratio that provides a use solution having desired detersive properties. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water, inclusive of all integers with this range, e.g., 1:50, 1:100, 1:1,000, and the like. Particularly, the concentrate is diluted at a ratio of between about 1:100 and about 1:5,000 concentrate to diluent. In an embodiment, the compositions are diluted to a concentration of between about 0.1 g/L to about 10 g/L, preferably between about 0.5 g/L to about 8 g/L.

If the textile emulsification composition is a solid, it may be in various forms including, but not limited to, a powder, a flake, a granule, a pellet, a tablet, a lozenge, a puck, a briquette, a brick, a solid block, or a unit dose. Moreover, the methods can include one or more of the following: a prewash cleaning composition, a main wash cleaning composition, pretreatment compositions (including but not limited to soaks and sprays.

### Alcohol Ethoxylate Nonionic Surfactants

In embodiments, the compositions include one or more alcohol ethoxylate nonionic surfactants, particularly those which are branched or semi-branched. In a preferred embodiment, the compositions include two branched alcohol ethoxylate nonionic surfactants.

In an embodiment, the compositions include one or more alcohol ethoxylate nonionic surfactants according to the following formula:

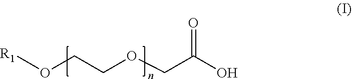

wherein R₁ is a linear or branched, saturated or unsaturated, substituted or unsubstituted alkyl group with a chain length of between 2 and 20, preferably between 10 and 16, more preferably between 12 to 14; and wherein n is an integer between 2 and 12, preferably between 5 and 9, more preferably 5 or 9.

In a preferred embodiment, the compositions comprise one or more nonionic ethoxylates comprising iso-alcohol ethoxylates such as iso-C₁₂-C₁₄ alcohol ethoxylates, such as preferably one or more iso-C₁₃alcohol ethoxylates consistent with formula I: RO(CH₂CH₂O)ₓH, wherein R is an iso-C₁₃ and x is 2, 3, 5, 6, 6, 5, 7, 8, 10, 11, 12, 15, 20; and combinations thereof.

In a further preferred embodiment, the composition comprises the one or more nonionic ethoxylates as an iso-alcohol ethoxylate, such as a C₁₂₋₁₄ alcohol polyethylene glycol ether mixture comprising a mixture of fatty alcohols with 9 moles ethylene oxide (9 EO) and fatty alcohols with 5 moles ethylene oxide (5 EO), and combinations thereof.

In an embodiment, the alcohol ethoxylate is a branched alcohol ethoxylate according to the formula:

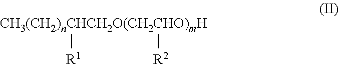

wherein R¹ is a C₂-C₂₀ alkyl, R² is H or a C₁-C₄ alkyl, n is 2-20, and m is 1-5;

In a preferred embodiment, the one or more nonionic surfactants comprise a C₁₂₋₁₄ alcohol polyethylene glycol ether mixture such as a mixture of fatty alcohols with 9 mol ethylene oxide and fatty alcohols with 5 mol ethylene oxide.

In a preferred embodiment, the compositions include a first branched alcohol ethoxylate comprising a C₁₂-C₁₃ alcohol polyethylene glycol ether having between 9 moles EO and 10 moles EO, preferably 9 moles EO, and a second branched alcohol ethoxylate comprising a C₁₂-C₁₃ alcohol polyethylene glycol ether having between 3 moles EO to 7 moles EO, preferably 5 moles EO.

Suitable 8 moles EO to 10 moles EO alcohol polyethylene glycol ethers include, but are not limited to, those sold under the names of Cosmacol® AE-7, Novel®23 E7, Safol® 23 E7, Safol® EN 70, Lialet®123-8, Cosmacol® N II 9, Novel®23 E9, Safol®23 E9, Safol® EN 90, Lialet®123-9.5, Cosmacol® AE-10, and Lialet®123-10.

Suitable 3 moles EO to 7 moles EO alcohol polyethylene glycol ethers include, but are not limited to, those sold under the names of Lialet®123-3, Novel® 23 E3, Safol®23 E3, Lialet®123-4, Novel® 23 E5, Safol® 23 ES, Safol® EN 50, Lutensol® TO5, Lutensol® XP5, Cosmacol® AE-7, Novel®23 E7, Safol® 23 E7, Safol® EN 70.

Particularly preferred alcohol ethoxylates include, but are not limited to, isotridecanol ethoxylate (7 EO), branched alcohol alkoxylates (9 EO), LA-7, LA-9, Lutensol® M7, Lutensol® AO7, isotridecyl alcohol (9 EO), AEO-9, Multiso®13/90, Multiso®13/50, Marlosol® LF-9, Safol® EN-50, Marlipal®24/939, Marlosol® LF-9, Lutensol® TO 8, Lutensolt TO 9, Safol® EN 90, or a combination thereof.

### Organic Solvent

In an embodiment, the compositions comprise one or more solvents, preferably organic solvents. In an embodiment, the one or more organic solvents comprise solvents such as an alcohol, a glycol, an ether, a ketone, or a combination thereof. In a preferred embodiment, the organic solvent comprises a lower alkyl alcohol, a propylene glycol, or a combination thereof.

A lower alkyl alcohol solvent includes compounds of the general formula ROH where R is linear or branched, substituted or unsubstituted C₁₋₈ alkyl group and OH is the hydroxyl group; a ketone solvent includes organic compounds with a carbonyl group attached to two carbon atoms, and a glycol solvent refers to an organic compound containing two hydroxyl groups; an ether solvent includes organic compounds containing an ether group, namely an oxygen connected to two alkyl or aryl groups according to the general formula R—O—R′.

Suitable organic solvents include but are not limited 1-methoxy-2-propanol, 2-m ethoxy ethanol, acetic acid, acetone, acetonitrile, amylalcohol, benzene, 1-butanol, 2-butanol, or other butanols, 2-butanone, t-butyl alcohol, carbon tetrachloride, chlorobenzene, chloroform, cyclohexane, cyclopentane, 1,2-dichloroethane, dichloromethane, diethylene glycol, diethyl ether, diethylene glycol dimethyl ether, 1,2-dimethoxy-ethane, dimethyl acetamide, dimethyl formamide, dimethyl sulfoxide, 1,4-dioxane, ethanol/ethyl alcohol, ethyl acetate, ethyl methyl ketone, ethylene glycol, glycerin, heptane, hexamethylphosphoramide, hexamethylphosphorous triamine, hexane, isopropylcarbinol, isopropyl alcohol, methanol/methyl alcohol, methyl t-butyl ether, methylene chloride, N,N-dimethyl formamide, N-methyl-2-pyrrolidone, n-butyl acetate, n-propyl alcohol, nitromethane, pentane, petroleum ether, 1-propanol, 2-propanol, propyl alcohol, propylene glycol, pyridine, sec-butyl alcohol, tetrahydrofuran, toluene, triethyl amine, trimethyl carbinol, water, o-dichlorobenzene, o-xylene, m-xylene, p-xylene, virahol, or a combination thereof.

Preferably, the organic solvent is a mixture of a glycol and a lower alkyl alcohol.

Particularly preferred organic solvents include, but are not limited to diethylene glycol monobutyl ether, ethylene glycol monobutyl ether, 2-butoxyethanol, ethylene glycol phenyl ether, propylene glycol, including propylene glycol phenyl ether, hexylene glycol, or a combination thereof.

More preferably, the organic solvent is a mixture of isopropyl alcohol and propylene glycol.

### Defoaming Agent

In some embodiments, the compositions can comprise a defoamer. Defoaming agents include a variety of different materials adapted for defoaming a variety of compositions. Defoaming agents can comprise an anionic or nonionic materials such as polyethylene glycol, polypropylene glycol, fatty acids and fatty acid derivatives, fatty acid sulfates, phosphate esters, sulfonated materials, silicone-based compositions, ethylene oxide and/or propylene oxide (EO/PO)-containing compounds, and others.

Suitable EO/PO-containing defoamfing agents include but are not limited to polyoxyalkylene alkyl ethers, for example those according to the formula

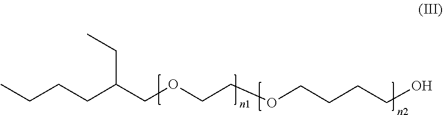

wherein n₁ is an integer of between 1-2 and n₂ is an integer of between 1-2. Preferably the compound according to the formula (III) has an 1-1113 value of 8 or less. When the HLB value is 8 or less, without being bound by theory, it is thought that the compatibility with the organic solvent(s) is improved. Suitable polyoxyalkylene alkyl ethers include, for example, ethoxylated propoxylated 2-ethyl-1-hexanol, such as LFE-1410 and LFE-635.

Suitable silicone defoaming agents include, without limitation, a polydialkylsiloxane, such as polydimethylsiloxane, or a silicone emulsion such as silicone emulsion. In some embodiments, silicone-based defoaming agents can be combined with silica, including, for example silica, fumed silica, derivatized silica, and silanized silica.

Suitable fatty acid defoaming agents include, without limitation, simple alkali metal or alkaline earth metal salts of a fatty acid or fatty acid derivatives. Examples of such derivatives include mono, di- and tri-fatty acid esters of polyhydroxy compounds such as ethylene glycol, glycerin, propylene glycol, hexylene glycol, etc. Such defoaming agents can comprise a fatty acid monoester of glycerol. Fatty acids useful in such defoaming efficacy can include any C₈₋₂₄ saturated or unsaturated, branched or unbranched mono or polymeric fatty acid and salts thereof, including for example myristic acid, palmitic acid, stearic acid, behenic acid, lignoceric acid, palmitoleic acid, oleic acid, linoleic acid, arachidonic acid, or a combination thereof.

In an embodiment, the compositions are free of APE defoaming agents. In a further embodiment, the compositions are free of non-biodegradable surfactants, such as ABS.

### Additional Surfactants

The compositions may optionally include one or more additional nonionic, semi-polar nonionic, cationic, anionic, zwitterionic, or amphoteric surfactants. In an embodiment, the compositions are free of additional surfactants, such as additional nonionic, semi-polar nonionic, cationic, anionic, zwitterionic, or amphoteric surfactants.

Optional additional nonionic surfactants are those characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties. Suitable nonionic surfactants include ethoxylated tridecyl alcohols, such as those sold under the trade name TDA, e.g., TDA 9; C12-C14 alcohol ethoxylates having 5-9 mole E, such as those sold under the trade name Surfonic L24-7; and polyoxyethylene castor oil ether, commercially available as EL-20.

Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds is tetra-functional block copolymers derived from the sequential addition of propylene oxide and ethylene oxide to ethylenediamine. The molecular weight of the propylene oxide ranges from about 500 to about 7,000; and the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range, or it can consist of an alcohol having a specific number of carbon atoms within this range. Examples of like commercial surfactant are available under the trade names Lutensol™, Dehydol™ manufactured by BASF, Neodol™ manufactured by Shell Chemical Co., and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the carbon atoms range, or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this disclosure for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty esters or acylated carbohydrates to compositions of the present disclosure containing amylase or lipase enzymes because of potential incompatibility.

Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic M R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Compounds from groups (1), (2), (3), and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block, or all-heteric nonionics.

Additional examples of effective low foaming nonionics include:

The alkylphenoxypolyethoxyalkanols of U.S. Pat. No. 2,903,486 issued Sep. 8, 1959, to Brown et al. and represented by the formula

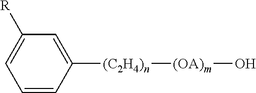

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962, to Martin et al. having alternating hydrophilic oxyethylene chains and hydrophobic oxypropylene chains where the weight of the terminal hydrophobic chains, the weight of the middle hydrophobic unit, and the weight of the linking hydrophilic units each represent about one-third of the condensate.

The defoaming nonionic surfactants disclosed in U.S. Pat. No. 3,382,178 issued May 7, 1968, to Lissant et al. having the general formula Z[(OR)ₙOH]_{z}, wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954, to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and in has a value such that the oxyethylene portion constitutes about 10% to about 90% by weight of the molecule.

The conjugated polyoxyalkylene compounds described in U.S. Pat. No. 2,674,619, issued Apr. 6, 1954, to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has a value such that the oxyethylene content of the molecule is from about 10% to about 90% by weight. Compounds falling within the scope of the definition for Y include, for example, propylene glycol, glycerin, pentaerythritol, trimethylolpropane, ethylenediamine, and the like. The oxypropylene chains optionally, but advantageously, contain small amounts of ethylene oxide, and the oxyethylene chains also optionally, but advantageously, contain small amounts of propylene oxide.

Additional conjugated polyoxyalkylene surface-active agents which are advantageously used in the compositions of this disclosure correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case, the oxypropylene chains may contain optionally, but advantageously, small amounts of ethylene oxide, and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxy hydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Fatty alcohol nonionic surfactants, including ethoxylated C₆-C₁₈ fatty alcohols and C₆-C₁₈ mixed ethoxylated and propoxylated fatty alcohols and fatty alcohol polyglycol ethers. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose, and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, or 6-positions on the preceding saccharide units.

Fatty acid amide surfactants suitable for use in the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

A useful class of non-ionic surfactants includes the class defined as alkoxylated amines or, most particularly, alcohol alkoxylated/aminated/alkoxylated surfactants. These non-ionic surfactants may be at least in part represented by the general formulae: R²—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A suitable chemical of this class includes Surfonic™ PEA 25 Amine Alkoxylate. Suitable nonionic surfactants for the compositions of the disclosure include alcohol alkoxylates, EO/PO) block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present disclosure. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry, and Berch).

### Semi-Polar Nonionic Surfactants

The semi-polar nonionic surface-active agents are another class of nonionic surfactants useful in compositions of the present disclosure. Generally, semi-polar nonionics are high foaming and foam stabilizers, which can limit their application in CIP systems. However, within compositional embodiments of this disclosure designed for high foam cleaning methodology, semi-polar nonionics would have immediate utility. The semi-polar nonionic surfactants include the amine oxides, phosphine oxides, sulfoxides, and their alkoxylated derivatives.

Amine oxides are tertiary amine oxides corresponding to the general formula

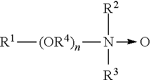

wherein the arrow is a conventional representation of a semi-polar bond; and R¹, R² and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g., through an oxygen or nitrogen atom, to form a ring structure; R⁴ is an alkaline or a hydroxyalkylene group containing 2 to 3 carbon atoms, and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water-soluble phosphine oxides having the following structure:

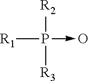

wherein the arrow is a conventional representation of a semi-polar bond; and R¹ is an alkyl, alkenyl, or hydroxyalkyl moiety ranging from 10 to about 24 carbon atoms in chain length; and R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethyl hexadecyl phosphine oxide, diethyl-2-hydroxyoctyldecylphosphine oxide, bis(2-hydroxyethyl)dodecyl phosphine oxide, and bis(hydroxymethyl)tetradecyl phosphine oxide.

Semi-polar nonionic surfactants useful herein also include the water-soluble sulfoxide compounds which have the structure:

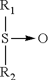

wherein the arrow is a conventional representation of a semi-polar bond; and R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the disclosure include dimethyl amine oxides, such as lauryl dimethyl amine oxide, myristyl dimethyl amine oxide, cetyl dimethyl amine oxide, combinations thereof, and the like. Useful water-soluble amine oxide surfactants are selected from the octyl, decyl, dodecyl, isododecyl, coconut, or tallow alkyl di-(lower alkyl) amine oxides, specific examples of which are octyl dimethyl amine oxide, nonyl dimethyl amine oxide, decyl dimethyl amine oxide, undecyl dimethyl amine oxide, dodecyldimethyl amine oxide, iso-dodecyldimethyl amine oxide, lauryl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present disclosure include alkoxylated surfactants. Suitable alkoxylated surfactants include EO/PO) copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

### Anionic Surfactants

Also useful in the present disclosure are surface-active substances which are categorized as anionics because the charge on the hydrophobe is negative; or surfactants in which the hydrophobic section of the molecule carries no charge unless the pH is elevated to neutrality or above (e.g., carboxylic acids). Carboxylate, sulfonate, sulfate, and phosphate are the polar (hydrophilic) solubilizing groups found in anionic surfactants. Of the cations (counter ions) associated with these polar groups, sodium, lithium, and potassium impart water solubility; ammonium and substituted ammonium ions provide both water and oil solubility; and calcium, barium, and magnesium promote oil solubility. As those skilled in the art understand, anionics are excellent detersive surfactants and are therefore favored additions to heavy-duty cleaning compositions.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates, and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and aromatic sulfonates with or without substituents.

Anionic carboxylate surfactants suitable for use in the present compositions include carboxylic acids (and salts), such as alkanoic acids (and alkanoates), ester carboxylic acids (e.g., alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants, and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates. The secondary carboxylate surfactants typically contain no ether linkages, no ester linkages, and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)
in which R is a C₈ to C₂₂ alkyl group or

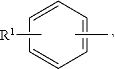

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and in is 1. In some embodiments, R is a C₈-C₁₆ alkyl group. In some embodiments, R is a C₁₂-C₁₄ alkyl group, n is 4, and m is 1.

In other embodiments, R is

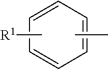

and R¹ is a C₆-C₁₂ alkyl group. In still yet other embodiments, R¹ is a C₉ alkyl group n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g., the product Sandopan® DTC, a C₁₃ alkyl polyethoxy (7) carboxylic acid.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g., alkyl amines), are also included in this group. In theory, cationic surfactants may be synthesized from any combination of elements containing an “onium” structure RnX+Y− and could include compounds other than nitrogen (ammonium) such as phosphorus (phosphonium) and sulfur (sulfonium). In practice, the cationic surfactant field is dominated by nitrogen-containing compounds, probably because synthetic routes to nitrogenous cationics are simple and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution, or more preferably indirectly by a bridging functional group or groups in so-called interrupted alkylamines and amido amines. Such functional groups can make the molecule more hydrophilic or more water dispersible, more easily water solubilized by co-surfactant mixtures, or water-soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or a saturated or unsaturated heterocyclic ring. In addition, cationic surfactants may contain complex linkages having more than one cationic nitrogen atom.

The surfactant compounds classified as amine oxides, amphoterics, and zwitterions are themselves typically cationic in near neutral to acidic pH solutions and can overlap surfactant classifications. Polyoxyethylated cationic surfactants generally behave like nonionic surfactants in alkaline solutions and like cationic surfactants in acidic solutions.

The simplest cationic amines, amine salts, and quaternary ammonium compounds can be schematically drawn thus:

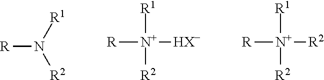

in which R represents an alkyl chain, R′, R″, and R″′ may be either alkyl chains or aryl groups or hydrogen and X represents an anion. The amine salts and quaternary ammonium compounds are suitable for practical use in this disclosure due to their high degree of water solubility.

The majority of large volume commercial cationic surfactants can be subdivided into four major classes and additional sub-groups for example as described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkyl benzyl dimethyl ammonium salts, alkylbenzene salts, heterocyclic ammonium salts, tetraalkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present disclosure include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

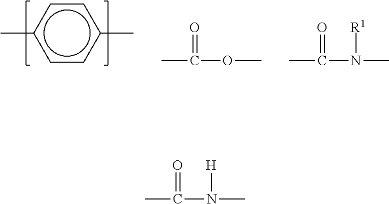

or an isomer or mixture of these structures, which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when in is 3. Each R² is an alkyl or hydroxyalkyl group containing from 1 to 4 carbon atoms or a benzyl group with no more than one R₂ in a molecule being benzyl, and x is a number from 0 to 11, preferably from 0 to 6. The remainder of any carbon atoms positioned on the Y group is filled by hydrogens.

Y is a group including, but not limited to:

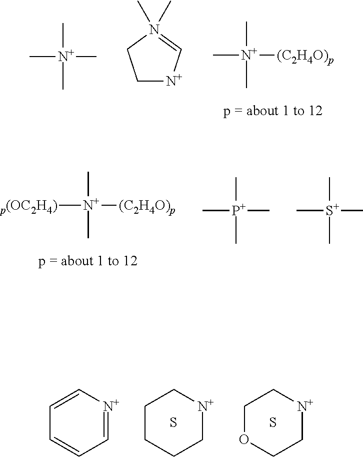

or a mixture thereof, Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly suitable being chloride, bromide, iodide, sulfate, or methyl sulfate anions, in a number to give electrical neutrality of the cationic component.

Additional suitable cationic surfactants include those derived from coconut products such as coconut oil or coconut fatty acid. Additional suitable coconut-derived surfactants include, for example, complex fatty tertiary amines with cationic surfactant properties, both as free amines and in the salt form. Such surfactants include, but are not limited to N,N-Diethoxylated-N-coco-N-methylammonium chloride (also sometimes referred to as Coconut oil alkyl)bis(2-hydroxyethyl, ethoxylated)methylammonium

Chloride) Such surfactants are commercially available under the trade names Ameenex™, specifically Ameenix™ 1154 and Rewoquat, specifically Rewoquat CQ 100 G.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate, or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g., 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present disclosure generally have the general formula:
(mono)acetate (di)propionate

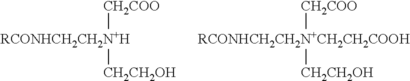

Neutral pH Zwitterion
Amphoteric Sulfonate

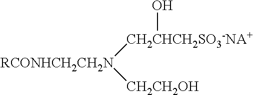

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example cocoamphopropionate, cocoamphocarboxy-propionate, cocoamphoglycinate, cocoamphocarboxy-glycinate, cocoamphopropyl-sulfonate, and cocoamphocarboxy-propionic acid. A particularly suitable amphoteric is disodium cocoamphodipropionate, commercially available as Mackam 2CSF. Amphocarboxylic acids can be produced from fatty imidazolines in which the dicarboxylic acid functionality of the amphodicarboxylic acid is diacetic acid or dipropionic acid. The carboxymethylated compounds (glycinates) described herein above frequently are called betaines.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this disclosure include alkyl beta-amino dipropionates, RN(C₂H₄COOM)₂, and RNFIC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut-derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut-derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. 1 and II by Schwartz, Perry, and Berch). Each of these references is herein incorporated by reference in its entirety.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium, or tertiary sulfonium compounds. Typically, a zwitterionic surfactant includes a positive charged quaternary ammonium or, in some cases, a sulfonium or phosphonium ion; a negatively charged carboxyl group; and an alkyl group. Zwitterionics generally contain cationic and anionic groups which ionize to a nearly equal degree in the isoelectric region of the molecule, and which can develop strong” inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

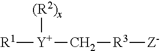

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

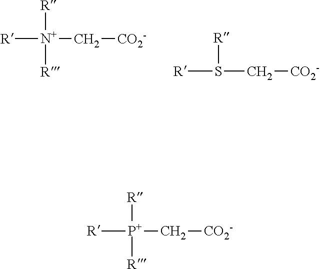

These surfactant betaines typically do not exhibit strong cationic or anionic characters at pH extremes, nor do they show reduced water solubility in their isoelectric range. Unlike “external” quaternary ammonium salts, betaines are compatible with anionics, Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethiylbetaine.

Sultaines useful in the present disclosure include those compounds having the formula (R(R¹)₂N⁺ R²SO³⁻, in which R is a C₆-C₁₈ hydrocarbyl group, each R¹ is typically independently C₁-C₃ alkyl, e.g., methyl, and R² is a C₁-C₆ hydrocarbyl group, e.g., a C₁-C₃ alkylene or hydroxyalkylene group.

### Alkalinity Source

The compositions may optionally include an alkalinity source to aid in soil removal efficacy. The alkalinity source can include an alkali metal carbonate, an alkali metal hydroxide, alkaline metal silicate, alkaline metal metasilicate, or a combination thereof. Suitable metal carbonates that can be used include, for example, sodium or potassium carbonate, bicarbonate, sesquicarbonate, or a combination thereof. Suitable alkali metal hydroxides that can be used include, for example, sodium, lithium, or potassium hydroxide. Examples of useful alkaline metal silicates include sodium or potassium silicate (with M₂O:SiO₂ ratio of 2.4 to 5:1, M representing an alkali metal) or metasilicate. A metasilicate can be made by mixing a hydroxide and silicate. The alkalinity source may also include a metal borate such as sodium or potassium borate, and the like.

In some embodiments, the compositions are free of an alkalinity source.

### Chelating Agent

The compositions may optionally include one or more chelating agents. As used herein “chelating agents” are compounds capable of coordinating (i.e., binding) metal ions commonly found in hard or natural water to prevent the metal ions from interfering with the action of the other detersive ingredients of an antimicrobial multi-purpose composition.

Suitable chelants can comprise an organic water conditioning agent including polymeric and small molecule water conditioning agents. Organic small molecule water conditioning agents are typically organocarboxylate compounds or organophosphate water conditioning agents. Polymeric inhibitors commonly comprise polyanionic compositions such as polyacrylic acid compounds (PAA).

Preferred small molecule organic water conditioning agents include, but are not limited to: sodium gluconate, sodium glucoheptonate, N-hydroxyethylenediaminetriacetic acid (HEDTA), ethylenediaminetetraacetic acid (EDT A), nitrilotriacetic acid (NT A), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxyrnethyl glutamic acid tetrasodium salt (GLDA), methylglycine-N—N-diacetic acid trisodium salt (MGDA), 1-hydroxyethylidene-1,1-diphosphponic acid (HEDP), iminodisuccinate sodium salt (IDS), or a combination thereof.

Preferred inorganic water conditioning agents include, but are not limited to, sodium tripolyphosphate and other higher linear and cyclic polyphosphates species. Suitable condensed phosphates include sodium and potassium orthophosphate, sodium and potassium pyrophosphate, sodium tripolyphosphate, and sodium hexametaphosphate. A condensed phosphate may also assist, to a limited extent, in the solidification of the solid detergent composition by fixing the free water present in the composition as water of hydration. Examples of phosphonates included, but are not limited to: 1-hydroxyethane-1,1-diphosphonic acid, CH₃C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₂₈₋ₓN₃NaₓO₁₅P₅ (x=7); hexamethylenediamine(tetramethylenephosphonate), potassium salt, C₁₀H₂₈₋ₓN₂KₓO₁₂P₄ (x=6); bis(hexamethylene)triamine(pentamethylienephosphonic acid), (HO₂)POCH₂N[(CH₂)(N[CH₂PO(OH)₂]₂]₂; and phosphorus acid, H₃PO₃. A preferred phosphonate combination is ATMP and DTPMP. A neutralized or alkaline phosphonate, or a combination of the phosphonate with an alkali source before being added into the mixture such that there is little or no heat or gas generated by a neutralization reaction when the phosphonate is added is preferred.

In an embodiment, the compositions are substantially free of phosphates and/or phosphonates.

### Additional Functional Ingredients

The compositions optionally can further be combined with various functional components suitable for use in laundering applications. In some embodiments, the cleaning composition including the acrylic acid polymers, water, stabilizing agents (chelants), and water conditioning polymers make up a large amount, or even substantially all of the total weight of the cleaning composition. For example, in some embodiments, few or no additional functional ingredients are included therein.

In other embodiments, additional functional ingredients may be included in the compositions. The functional ingredients provide desired properties and functionalities to the compositions. As used herein, the term “functional ingredient” or “additional functional ingredient” includes a material that when dispersed or dissolved in a use or concentrate solution, such as an aqueous solution, provides a beneficial property in a particular use. Some particular examples of functional materials are discussed in more detail below, although the particular materials discussed are given by way of example only, and a broad variety of other functional ingredients may be used

Additional functional ingredients may include further defoaming agents, bleaching agents or optical brighteners, solubility modifiers, buffering agents, dye transfer inhibiting agents, dispersants, stabilizing agents, sequestrants or chelating agents to coordinate metal ions and control water hardness, fragrances or dyes, rheology modifiers or thickeners, hydrotropes or couplers, buffers, solvents and the like.

In an aspect, the compositions include from about 0 wt. % to about 25 wt. % additional functional ingredients, from about 0 wt. % to about 20 wt,% additional functional ingredients, from about 0 wt. % to about 10 wt. % additional functional ingredients, or from about 0 wt. % to about 5 wt,% additional functional ingredients, inclusive of all integers within these ranges.

### Colorant

The compositions can optionally comprise a colorant, Preferred colorants include natural and synthetic colorants or dyes. Most preferably the colorant comprises FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hlisol Fast Red (Capitol Color and Chemical), Fluorescein (Capitol Color and Chemical), Acid Green 25 (Ciba-Geigy), or a combination thereof.

In an aspect, the colorant or dye may comprise dyes that are generally recognized as safe. Suitable dyes include, but are not limited to, FDC Blue #1, FDC Blue #2, FDC Green #3, FDC Red #3, FDC Red #4, FDC Red #40, Violet #1, FDC Yellow #5, and FDC Yellow #6.

When present, the colorant may be present in an amount of between about 0.001 wt. % and about 5 wt. %, more preferably between about 0.01 wt. % and about 2 wt. %, most preferably between about 0.1 wt. % and about 1 wt. %, inclusive of all integers within this range.

### Fragrance

The finishing composition can optionally comprise a fragrance. Preferred fragrances include natural and synthetic fragrances and perfumes. Most preferably the fragrance comprises terpenoids such as citronellol, aldehydes such as amyl cinnamaldehyde, a jasmine such as CIS-jasmine or jasmal, vanillin, and the like, or a mixture thereof.

### Solidification Agent

If it is desirable to prepare compositions as a solid, one or more solidification agents may be included in the composition. In some embodiments, the solidification agent can form or maintain the composition as a solid rinse aid composition. In other embodiments, the solidification agent can solidify the composition without unacceptably detracting from the eventual release of the active ingredients. The solidification agent can include, for example, an organic or inorganic solid compound having a neutral inert character or making a functional, stabilizing, or detersive contribution to the present composition. Suitable solidification agents include solid polyethylene glycol (PEG), solid polypropylene glycol, solid EO/PO block copolymer, amide, urea (also known as carbamide), nonionic surfactant (which can be employed with a coupler), anionic surfactant, starch that has been made water-soluble (e.g., through an acid or alkaline treatment process), cellulose that has been made water-soluble, inorganic agent, poly(maleic anhydride/methyl vinyl ether), polymethacrylic acid, other generally functional or inert materials with high melting points, mixtures thereof, and the like.

Suitable glycol solidification agents include a solid polyethylene glycol or a solid polypropylene glycol, which can, for example, have a molecular weight of about 1,400 to about 30,000. In certain embodiments, the solidification agent includes or is solid PEG, for example, PEG 1500 up to PEG 20,000. In certain embodiments, the PEG includes PEG 1450, PEG 3350, PEG 4500, PEG 8000, PEG 20,000, and the like. Suitable solid polyethylene glycols are commercially available from Union Carbide under the tradename Carbowax.

Suitable amide solidification agents include stearic monoethanolamide, lauric diethanolamide, stearic diethanolamide, stearic monoethanol amide, coco diethylene amide, an alkylamide, urea, or a combination thereof.

Suitable inorganic solidification agents include phosphate salt (e.g., alkali metal phosphate), sulfate salt (e.g., magnesium sulfate, sodium sulfate, or sodium bisulfate), acetate salt (e.g., anhydrous sodium acetate), Borates (e.g., sodium borate), Silicates (e.g., the precipitated or fumed forms (e.g., Sipernat 50@available from Degussa), carbonate salt (e.g., calcium carbonate or carbonate hydrate), other known hydratable compounds, mixtures thereof, and the like. In an embodiment, the inorganic solidification agent can include organic phosphonate compound and carbonate salt, such as an E-Form composition.

When present, the one or more solidification agents may be present in an amount of between about 1 wt.-% to about 99 wt. %, between about 5 wt. % to about 90 wt. %, or between about 15% to about 70 wt. %, inclusive of all integers within these ranges.

### Bleaching Agent

The compositions can optionally include a whitening or bleaching agent. Such can be included in a cleaning composition or part of a separate whitening/bleaching step. Suitable whitening agents include halogen-based bleaching agents and oxygen-based bleaching agents. The whitening agent can be added to the cleaning compositions; however, in some embodiments of the disclosure, the whitening agent can be used in the pre-soak or pre-treatment step so that the later laundering step may be free of bleaching agents. This can be beneficial in formulating solid cleaning compositions as there can be difficulties in formulating solid compositions with bleaching agents.

Suitable oxygen-based bleaches include peroxygen bleaches, such as sodium perborate (tetra- or monohydrate), sodium percarbonate, or hydrogen peroxide. These are preferably used in conjunction with a bleach activator which allows the liberation of active oxygen species at a lower temperature.

Peroxybenzoic acid precursors are also suitable bleaching agents. Examples of suitable precursors are phenylbenzoate, phenyl p-nitrobenzoate, o-nitrophenyl benzoate, o-carboxyphenyl benzoate, p-bromophenyl benzoate, sodium or potassium benzoyloxy benzene sulfonate, and benzoic anhydride.

Suitable peroxygen bleach precursors are sodium p-benzoyloxy-benzene sulfonate, N,N,N,N-tetraacetyl ethylene diamine (TEAD), sodium nonanoyl oxybenzene sulfonate (SNOBS), and choline sulphophenyl carbonate (CSPC).

### Qptical Brightener

In some embodiments, an optical brightener component may be utilized in the compositions. The optical brightener can include any brightener that is capable of lessening graying and yellowing of textiles. Typically, these substances attach to the fibers and bring about a brightening action by converting invisible ultraviolet radiation into visible longer-wavelength light, the ultraviolet light absorbed from sunlight being irradiated as a pale bluish fluorescence and, together with the yellow shade of the grayed or yellowed laundry, producing pure white.

Fluorescent compounds belonging to the optical brightener family are typically aromatic or aromatic heterocyclic materials often containing condensed ring systems. An important feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five-membered heterocycles (triazoles, oxazoles, imidazoles, etc.) or six-membered heterocycles (cumarins, naphthalamides, triazines, etc.).

Commercial optical brighteners which may be useful in the present disclosure can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles, and other miscellaneous agents. Examples of these types of brighteners are disclosed in “The Production and Application of Fluorescent Brightening Agents,” M. Zahradnik, Published by John Wiley & Sons, New York (1982), the disclosure of which is incorporated herein by reference.

Stilbene derivatives that may be useful in the present disclosure include, but are not necessarily limited to, derivatives of bis(triazinyl)amino stilbene; bisacylamino derivatives of stilbene; triazole derivatives of stilbene; oxadiazole derivatives of stilbene; oxazole derivatives of stilbene; and styryl derivatives of stilbene. In an embodiment, optical brighteners include stilbene derivatives.

Additional optical brighteners include, but are not limited to 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazol, benzisoxazol and benzimidazol systems, and pyrene derivatives substituted by heterocycles, and the like. Suitable optical brightener levels include lower levels of from about 0.01, from about 0.05, from about 0.1, or even from about 0.2 wt. % to upper levels of 0.5 or even 0.75 wt. %.

### Methods of Cleaning Textiles

The methods of cleaning are particularly well suited for removing oily or greasy soils. While not wanting to be held to a scientific theory, it is believed that the hydrophobic portion of oily and greasy soils make the soil particularly difficult to remove from textiles.

The methods described herein may remove oily or greasy soils that accumulate on any type of textiles, namely any item or article made from or including natural fabrics, synthetic fabrics, woven fabrics, non-woven fabrics, and knitted fabrics. The textile materials can include natural or synthetic fibers such as silk fibers, linen fibers, cotton fibers, hemp fibers, angora fibers, bamboo fibers, polyester fibers, polyamide fibers such as nylon, acrylic fibers, acetate fibers, wool, rayon, cashmere, satin, spandex, and blends thereof, including cotton and polyester blends. The fibers can be treated or untreated. Example treated fibers include those treated for flame retardancy. It should be understood that the term “linen” describes a type of material derived from flax plants that is often used in certain types of laundry items including bed sheets, pillowcases, towels, table linen, tablecloth, bar mops, and uniforms.

The methods of cleaning include contacting a textile in need of removing soils, particularly oily or greasy soils. Any means of contacting can be used to place the textile surface in contact with the compositions, including, for example, soaking, spraying, dipping, wiping, or the like. Included within the scope of contacting described herein, the textile can also be soaked, including a pretreatment, with the compositions. As a result of the contacting step the textile is washed, and the soils removed.

In certain embodiments, a concentrate can be sprayed onto a textile surface or provided in water as part of a pre-treatment. The contacting time may vary about 10 seconds to six hours, for example, 1 minute to four hours, 10 minutes to two hours, 15 minutes to an hour, inclusive of all integers within this range. In another aspect, the pre-treatment may last as long as several hours (e.g., overnight soak).

In textile cleaning applications, the method of cleaning may comprise a first step of diluting or creating a use solution (such as from a solid) can also be included in the methods. An exemplary dilution step includes contacting the liquid or solid composition with water or another suitable solvent.

More particularly, in a typical cleaning method, the washing process comprises a pre-wash or pre-soak where the textiles are wetted, and a pre-soak composition is added. The wash phase follows the pre-soak phase; the compositions described herein are added to the wash tank to facilitate soil removal. In some cases, a bleach phase follows the wash phase in order to remove oxidizable stains and whiten the textiles. Next, the rinsing phase removes all suspended soils. In some cases, a laundry sour is added in a souring or finishing phase to neutralize any residual alkalinity from the composition or complete and post-treatment of the textiles needed. In many cases, a fabric softener or other finishing chemical like a starch is also added in the finishing step. Finally, the extraction phase removes as much water from the wash tank and textiles as possible. In some cases, a wash cycle may have two rinse and extraction phases, i.e., a rinse cycle, an intermediate-extract cycle, a final rinse cycle, and a final extraction cycle. After the wash cycle is complete, the resulting wastewater is typically removed and discarded. Although the compositions are typically contacted with the textiles in a pre-treatment or wash phase, the compositions can be contacted with the textiles during any one or more parts of the wash cycle.

The compositions disclosed herein may be contacted with the textiles during any phase of the wash cycle. Preferably, the compositions are diluted with water and contacted with the textiles during the pre-soak/pre-wash phase or the wash phase, still more preferably during the wash phase. In some embodiments, the compositions are not added during the bleaching phase or the softening or souring phase.

In some embodiments, after the compositions are contacted with the textiles, some of the composition remains on the surface of the textile for two or three more cycles, beneficially preventing soil-redeposition and aiding in soil removals.

When the compositions are diluted, they are diluted to a concentration of between about 0.1 g/L to about 10 g/L, preferably between about 0.5 g/L to about 8 g/L.

In an aspect, the compositions will contact the textile to be cleaned for a sufficient amount of time to remove the soils, including from a few seconds to a few hours, including all ranges therebetween. In an embodiment, the composition contacts the textiles for at least about 15 seconds, at least about 30 seconds, at least about 45 seconds, or at least about 60 seconds. In an embodiment, the composition contacts the textiles for at least about 1 minute, at least about 2 minutes, at least about 3 minutes, at least about 4 minutes, or at least about 5 minutes.

### EXAMPLES

### Example 7

Example formulations utilizing a variety of ethoxylated/alkoxylated surfactants were prepared according to Table 3 below.

TABLE 3

| | Ex. | Ex. | Ex. | Ex. | Ex. | Ex. | Ex. |
|---|---|---|---|---|---|---|---|
| Component | B1 | B2 | B3 | B4 | B5 | D1 | D2 |
| Isotridecanol Ethoxylate | 20 | 20 | | | | | |
| (7 EO) | | | | | | | |
| Branched Alcohol | 30 | 30 | 30 | 30 | | | |
| Alkoxylate (9 EO) | | | | | | | |
| Diethylene Glycol | 20 | 30 | 20 | 20 | 20 | 20 | 30 |
| Monobutyl Ether | | | | | | | |
| Linear Alcohol Alkoxylate | | | | | | 20 | 20 |
| (7 EO) | | | | | | | |
| Linear Alcohol Alkoxylate | | | | | | 30 | 30 |
| (9 EO) | | | | | | | |
| Alcohol Alkoxylate (7 EO) | | | | 20 | 50 | | |
| (e.g., Lutensol AO7) | | | | | | | |
| C10-C18 alcohol ethoxylate | | | 20 | | | | |
| (7 EO) (e.g., Lutensol M7) | | | | | | | |
| Water | 30 | 20 | 30 | 30 | 30 | 30 | 20 |

Table 3 illustrates several suitable compositions which beneficially provide effective oily soil removal which are cost-effective, and which do not require high concentrations (e.g., greater than 60%, greater than 70%, greater than 80%, etc.) of solvents.

### Example 2

Example formulations utilizing a variety of organic were prepared according to Table 4 below.

TABLE 4

| | Ex | Ex | Ex. | Ex. | Ex. | Ex. | Ex. | Ex. | Ex. | Ex. | Ex | Ex. | Ex. |
|---|---|---|---|---|---|---|---|---|---|---|---|---|---|
| Component | S1 | S2 | S3 | S4 | S5 | S6 | S7 | S8 | S9 | S10 | S11 | B1 | B2 |
| Isotridecanol | 20 | 20 | 20 | 20 | 20 | 20 | 30 | 20 | 20 | 20 | 20 | 20 | 20 |
| Ethoxylate | | | | | | | | | | | | | |
| (7 EO) | | | | | | | | | | | | | |
| Branched | 30 | 30 | 30 | 30 | 30 | 30 | 20 | 30 | 30 | 30 | 30 | 30 | 30 |
| Alcohol | | | | | | | | | | | | | |
| Alkoxylate | | | | | | | | | | | | | |
| (9 EO) | | | | | | | | | | | | | |
| Ethylene | 10 | 10 | | 10 | | | | | | | | | |
| Glycol n- | | | | | | | | | | | | | |
| Butyl Ether | | | | | | | | | | | | | |
| (c.g., BuCs) | | | | | | | | | | | | | |
| Hexylene | 10 | | 20 | | | | | | | | | | |
| Glycol | | | | | | | | | | | | | |
| Ethylene | | 10 | | | | | | | | | | | |
| Glycol | | | | | | | | | | | | | |
| Phenyl Ether | | | | | | | | | | | | | |
| (e.g., EPh) | | | | | | | | | | | | | |
| Propylene | | | | 10 | 15 | | | | | | | | |
| Glycol | | | | | | | | | | | | | |
| Phenyl Ether | | | | | | | | | | | | | |
| (e.g., PPh) | | | | | | | | | | | | | |
| Diethylene | | | | | | 45 | 45 | 25 | 10 | 15 | 20 | 20 | 30 |
| Glycol | | | | | | | | | | | | | |
| Monobutyl | | | | | | | | | | | | | |
| Ether | | | | | | | | | | | | | |
| Ethylene | | | | | | | | 20 | 10 | 15 | 20 | | |
| Glycol | | | | | | | | | | | | | |
| Monobutyl | | | | | | | | | | | | | |
| Ether | | | | | | | | | | | | | |
| Water | 30 | 30 | 30 | 30 | 35 | 5 | 5 | 5 | 30 | 20 | 10 | 30 | 20 |

Table 4 provides examples of suitable compositions, wherein the compositions beneficially provide effective oily soil removal cost-effectively without requiring high concentrations (e.g., greater than 60%, greater than 70% greater than 801%, etc.) of solvents.

### Example 3

A variety of surfactants and solvents were evaluated for their ability to remove stubborn soils, particularly oily soils, Compositions with various alkoxylated surfactants and organic solvents were prepared according to the table below. Cotton, polyester, and cotton/polyester blend textiles were provided and soiled with one of lanolin, vegetable oil, or vli oil. After soiling, the textiles were treated with a detergent formulation outlined in the table by contacting the textile with 1000 ml water, 0.5 g/L detergent, and 0.5 g/L builder in a tergotometer. The test was conducted at 65° C. in a tergotometer having a rpm of 100. After ten minutes of contacting the textile with the aqueous detergent composition, the textiles were removed from the water and allowed to dry.

Soil removal efficacy was calculated using the following formula:

Percent Removal: Soil Removal %=(L*final−L*initial)/(96−L*initial)*100, wherein the L* value is one of the color Indices and is indicative of broad visible spectrum reflectance, and where 100% is considered completely white, Percent stain removal was calculated using a spectrophotometer (ColorQuest XE, Hunter Associates Laboratory).

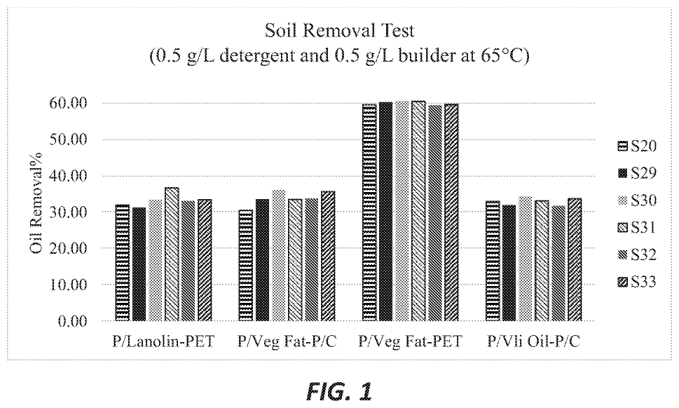

Formulas evaluated for their soil removal efficacy are shown in Tables 5-6 below and FIG. 1.

TABLE 5

| | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|
| Component | S12 | S13 | S14 | S15 | S16 | S17 | S18 | S19 | S20 | S21 | S22 | S23 | S24 |
| Isotridecanol | | | | | | 10 | | | | | | | |
| Ethoxylate (7 EO) | | | | | | | | | | | | | |
| Isotridecyl | | 50 | | | | | | | | | | | |
| Alcohol (9 EO) | | | | | | | | | | | | | |
| Branched Alcohol | 50 | | | | | | | | | | | | |
| Alkoxylate (9 EO) | | | | | | | | | | | | | |
| Diethylene Glycol | 20 | 20 | 20 | 20 | 20 | 20 | 20 | 10 | 10 | 10 | 10 | | 8 |
| Monobutyl Ether | | | | | | | | | | | | | |
| AEO-9 | | | 50 | | | | | | | | | | |
| Multiso 13/90 | | | | 50 | | | | | | | | | |
| 13/50 | | | | | | | | | | | | | 10 |
| LF-9 | | | | | 50 | 40 | 40 | 50 | 40 | 45 | 40 | 40 | 40 |
| EN50 | | | | | | | 10 | | 10 | 15 | 10 | 10 | |
| Ethylene Glycol | | | | | | | | 10 | 10 | 10 | 10 | | 7 |
| Monobutyl Ether | | | | | | | | | | | | | |
| Ethoxylated | | | | | | | | 5 | 5 | 5 | 5 | 5 | 5 |
| Propoxylated 2- | | | | | | | | | | | | | |
| ethyl-1-hexyl | | | | | | | | | | | | | |
| LFE1410 | | | | | | | | | | | | | |
| Propylene Glycol | | | | | | | | | | | | 7 | |
| Isopropyl Alcohol | | | | | | | | | | | | 8 | |
| Safol EN90 | | | | | | | | | | | | | |
| Water | 30 | 30 | 30 | 30 | 30 | 30 | 30 | 25 | 25 | 15 | 25 | 30 | 30 |

| | Ex. | Ex. | Ex. | Ex. | Ex. | Ex. | Ex. | Ex. | Ex. |
|---|---|---|---|---|---|---|---|---|---|
| Component | S25 | S26 | S27 | S28 | S29 | S30 | S31 | S32 | S33 |
| Isotridecanol | | | | | | | | | |
| Ethoxylate (7 EO) | | | | | | | | | |
| Isotridecyl | | | | | | | | | |
| Alcohol (9 EO) | | | | | | | | | |
| Branched Alcohol | | | | | | | | | |
| Alkoxylate (9 EO) | | | | | | | | | |
| Diethylene Glycol | 8 | 10 | 10 | 10 | | | | 10 | |
| Monobutyl Ether | | | | | | | | | |
| AEO-9 | | | | | | | | | |
| Multiso 13/90 | | | | | | | | | |
| 13/50 | | 10 | 20 | 10 | | | | | 20 |
| LF-9 | | 40 | 30 | 50 | 40 | 30 | 20 | 30 | 30 |
| EN50 | 10 | | | | 10 | 20 | 30 | 20 | [symbol] |
| Ethylene Glycol | 7 | 10 | 10 | 10 | | | | 10 | [symbol] |
| Monobutyl Ether | | | | | | | | | |
| Ethoxylated | 5 | 5 | 5 | 5 | 5 | 5 | 5 | 5 | [symbol] |
| Propoxylated 2- | | | | | | | | | |
| ethyl-1-hexyl | | | | | | | | | |
| LFE1410 | | | | | | | | | |
| Propylene Glycol | | | | | 10 | 10 | 10 | | [symbol] |
| Isopropyl Alcohol | | | | | 10 | 10 | 10 | | [symbol] |
| Safol EN90 | 40 | | | | | | | | [symbol] |
| Water | 30 | 25 | 25 | 15 | 25 | 25 | 25 | 25 | [symbol] |

[symbol]

indicates data missing or illegible when filed

TABLE 6

| | Ex. S20 | Ex. S29 | Ex. S30 | Ex. S30 | Ex. S31 | Ex. S32 | Ex. S33 | |
|---|---|---|---|---|---|---|---|---|
| Textile | Soil | Soil | Soil | Soil | Soil | Soil | Soil | |
| and | Remov. | Remov. | Remov. | Remov. | Remov. | Remov. | Remov. | |
| SoilType | (%) | (%) | (%) | (%) | (%) | (%) | (%) | Total |
| P/Lanolin- | 31.95 | 31.26 | 33.33 | 36.65 | 33.08 | 33.43 | 31.95 | 199.70 |
| PET | | | | | | | | |
| P/Veg | 30.58 | 33.60 | 36.08 | 33.52 | 33.73 | 35.68 | 30.58 | 203.17 |
| Fat-P/C | | | | | | | | |
| P/Veg | 59.49 | 60.21 | 60.49 | 60.44 | 59.39 | 59.56 | 59.49 | 359.58 |
| Fat-PET | | | | | | | | |
| P/Vli Oil- | 32.95 | 31.89 | 34.37 | 33.13 | 31.75 | 33.68 | 32.95 | 197.77 |
| P/C | | | | | | | | |
| Total | 154.97 | 156.95 | 164.27 | 163.73 | 157.94 | 162.35 | 154.97 | 960.21 |

### Example 4

Further evaluation was conducted regarding the detergency of surfactants of varying degrees of ethoxylation, carbon chain length, and branching. Example compositions were prepared with relevant surfactants as shown in Table 7 below.

TABLE 7

| Example | Surfactant |
|---|---|
| NSF1 | Iso-C8 EO9, PO6 |
| NSF2 | Iso-C13 EO9 |
| NSF3 | Linear C12 EO9 |
| NSF4 | Iso-C13 EO9 |
| NSF5 | Iso-C12 EO9 |
| NSF6 | Iso-C13 EO7 |

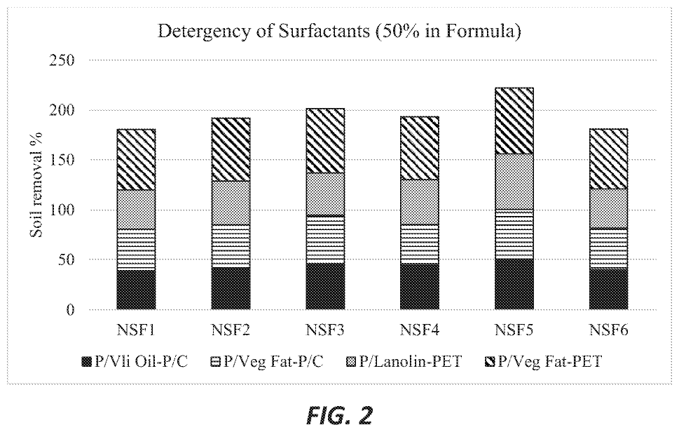

The results of this assessment are shown in FIG. 2. As shown in the Figure, the Iso-C12 EO9 surfactant provided improved detergency compared to linear ethoxylated surfactants and surfactants with a higher degree of ethoxylation.

### Example 5

Further evaluation was conducted regarding Iso-C12 alcohol ethoxylate surfactants together with a low-EO surfactant. Compositions were prepared according to Table 8 below.

TABLE 8

| Example | Surfactant | Ratio |
|---|---|---|
| F1 | 50% Iso-C12 EO9, Iso-C13 EO7 | 4:1 |
| F2 | 50% Iso-C12 EO9, Iso-C12 EO5 | 4:1 |
| F3 | 50% Iso-C12 EO9, Iso-C13 EO5 | 4:1 |
| F4 | 50% Iso-C12 EO9 | |

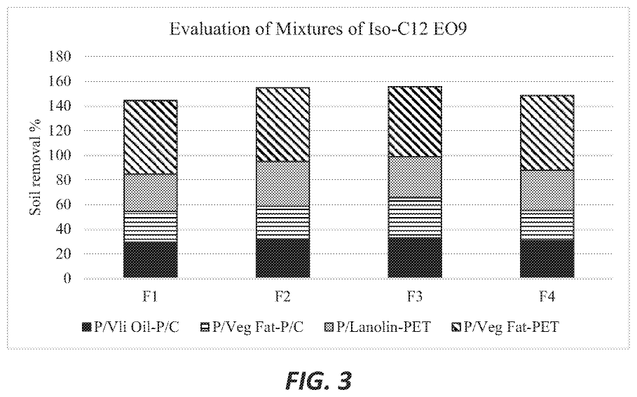

The results of this assessment are shown in FIG. 3. As shown in the Figure, the combination of the Iso-C12 EO9 surfactant together with an EO5 surfactant provided improved detergency compared to the EO9 surfactant alone, or the EO9 surfactant with a branched E07 surfactant.

### Example 6

Further evaluation was conducted regarding Iso-C₁₂ alcohol ethoxylate surfactants together with a low-EO surfactant at additional ratios. Compositions were prepared according to Table 9 below.

TABLE 9

| Example | Surfactant | Ratio |
|---|---|---|
| F5 | 50% Iso-C12 EO9 | |
| F6 | 50% Iso-C12 EO9, Iso-C12 EO5 | 4:1 |
| F7 | 50% Iso-C12 EO9, Iso-C12 EO5 | 3:2 |
| F8 | 50% Iso-C12 EO9, Iso-C12 EO5 | 2:3 |
| F9 | 50% Iso-C12 EO9, Iso-C12 EO5 | 3:1 |

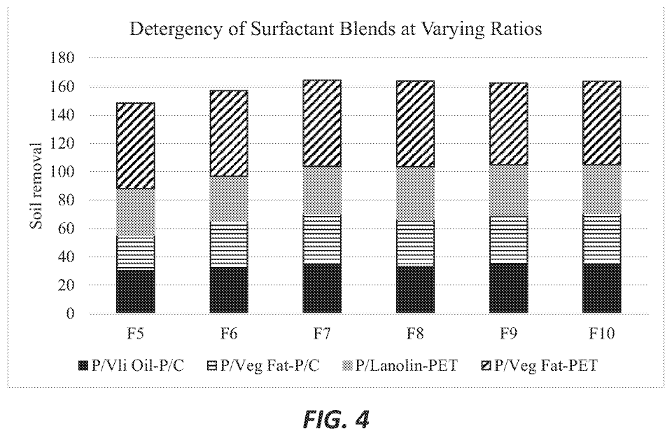

The results of this assessment are shown in FIG. 4. As shown in the Figure, the combination of the Iso-C12 EO9 surfactant together with an EO5 surfactant at a 3:2 ratio provided improved detergency. Additionally, given the cost of the Iso-C12 EO9 surfactant, the formula containing the Iso-C12 EO9 surfactant together with an EO5 surfactant is more cost-efficient.

### Example 7

Further evaluation was conducted of various organic solvents utilizing combinations of the organic solvents at differing ratios Compositions were prepared according to Table 10,

TABLE 10

| Example | Surfactant | Ratio |
|---|---|---|
| F10 | 20% Ethylene Glycol n-Butyl Ether | |
| F11 | 30% Ethylene Glycol n-Butyl Ether | |
| F12 | 45% Ethylene Glycol n-Butyl Ether | |
| F13 | Ethylene Glycol n-Butyl Ether/BuCe | 1:1 (10%, 10%) |
| F14 | Ethylene Glycol n-Butyl Ether/BuCe | 1:1 (15%, 15%) |
| F15 | Ethylene Glycol n-Butyl Ether/BuCe | 1:1 (20%, 20%) |
| F16 | IPA/PPG | 1:1 (10%, 10%) |

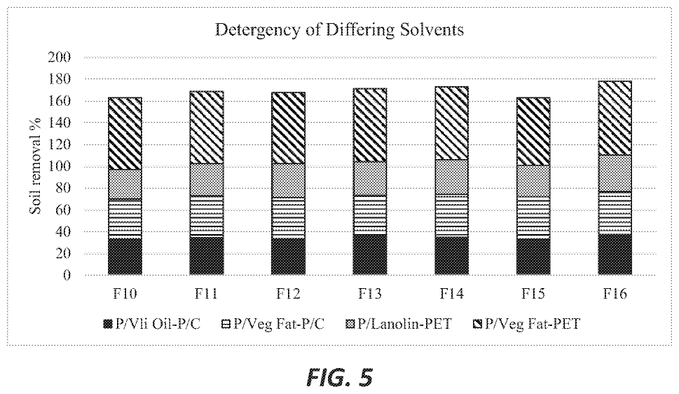

The results of this assessment are shown in FIG. 5. As shown in the Figure, the combination of isopropyl alcohol and propylene glycol together as a solvent at a ratio of 10% to 10% (1:1) provided improved detergency.

### Example 7

The formulations described herein were assessed for their shelf stability. Formulations were prepared according to those in Example 6 and additional formulations were prepared as shown in Table 11 below. These formulations were assessed for their soil removal capability (as shown in FIG. 4) and further for shelf stability.

TABLE 11

| Components of Formula F10 | Concentration (wt. %) |
|---|---|
| Isotridecyl C13 alcohol ethoxylate (9EO) | 30 |
| (e.g., Lutensol TDA9) | |
| Isotridecyl C13 alcohol ethoxylate (5EO) | 20 |
| (e.g., Lutensol TO5) | |
| Alcohol organic solvent (e.g., isopropyl alcohol) | 10 |
| Glycol organic solvent (e.g., propylene glycol) | 10 |
| Optional defoaming agent | 5 |
| (e.g., ethoxylated propoxylated 2-ethyl-1-hexanol) | |

As demonstrated in FIG. 4, the compositions provide good soil removal capability. Further, the formulation of Table 11 provided improved stability. The formulations of Example 6 provided good shelf stability at room temperature while exhibiting some hazing at high and low temperatures. Beneficially, the formulations of Table 11 demonstrated no hazing at room temperature as well as high and low temperatures.

The embodiments being thus described, it will be obvious that the same may be varied in many ways. Such variations are not to be regarded as a departure from the spirit and scope of the disclosure and all such modifications are intended to be included within the scope of the following claims.

1: A textile cleaning composition comprising:
a first alcohol ethoxylate having between 7 moles of ethylene oxide and 10 moles of ethylene oxide;
a second alcohol ethoxylate having between 3 moles of ethylene oxide and 7 moles of ethylene oxide;
a glycol solvent; and
an alcohol solvent.

2: The textile cleaning composition of claim 1, wherein the first alcohol ethoxylate is a compound according to the formula: 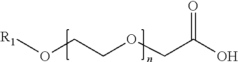
wherein R₁ is a linear or branched, saturated or unsaturated, substituted or unsubstituted alkyl group with a chain length of between 2 and 20; and wherein n is an integer between 7 and 10; and
wherein the second alcohol ethoxylate is a compound according to the formula: 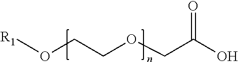
wherein R₁ is a linear or branched, saturated or unsaturated, substituted or unsubstituted alkyl group with a chain length of between 2 and 20; and wherein n is an integer between 3 and 6.

3: The textile cleaning composition of claim 1, wherein the alkyl group of the first alcohol ethoxylate has a chain length of between 10 and 15, and wherein the alkyl group of the second alcohol ethoxylate has a chain length of between 10 and 15.

4: The textile cleaning composition of claim 3, wherein the alkyl group of the first alcohol ethoxylate has a chain length of between 12 and 13, and wherein the alkyl group of the second alcohol ethoxylate has a chain length of between 12 and 13.

5: The textile cleaning composition of claim 1, wherein the glycol solvent is an ethylene glycol solvent, a propylene glycol solvent, or a combination thereof.

6: The textile cleaning composition of claim 1, wherein the alcohol solvent is ethanol, butanol, benzyl alcohol, isopropyl alcohol, or a combination thereof.

7: The textile cleaning composition of claim 1, wherein the glycol solvent is propylene glycol, and the alcohol solvent is isopropyl alcohol.

8: The textile cleaning composition of claim 1, further comprising a defoaming agent according to the formula: 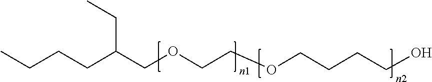
wherein n₁ is an integer of between 1-2 and n₂ is an integer of between 1-2.

9: The textile cleaning composition of claim 8, wherein the defoaming agent is present in an amount of from about 1 wt. % to about 10 wt. %.

10: The textile cleaning composition of claim 1, wherein the textile cleaning composition comprises between about 20 wt. % to about 50 wt. % of the first alcohol ethoxylate, from about 10 wt. % to about 30 wt. % of the second alcohol ethoxylate, from about 5 wt. % to about 15 wt. % of the alcohol solvent, and from about 5 wt. % to about 15 wt. % of the glycol solvent.

11: A method of cleaning a textile comprising:
contacting the textile with a textile cleaning composition comprising a first alcohol ethoxylate having between 7 moles of ethylene oxide and 10 moles of ethylene oxide; a second alcohol ethoxylate having between 3 moles of ethylene oxide and 7 moles of ethylene oxide; a glycol solvent; and an alcohol solvent; and
removing a soil from the textile.

12: The method of claim 11, wherein the first alcohol ethoxylate is a compound according to the formula: 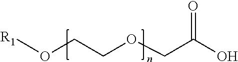
wherein R₁ is a linear or branched, saturated or unsaturated, substituted or unsubstituted alkyl group with a chain length of between 2 and 20; and wherein n is an integer between 7 and 10; and
wherein the second alcohol ethoxylate is a compound according to the formula: 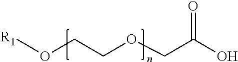
wherein R₁ is a linear or branched, saturated or unsaturated, substituted or unsubstituted alkyl group with a chain length of between 2 and 20; and wherein n is an integer between 3 and 6.

13: The method of claim 11, wherein the alcohol solvent is ethanol, butanol, benzyl alcohol, isopropyl alcohol, or a combination thereof, and wherein the glycol solvent is an ethylene glycol solvent, a propylene glycol solvent, or a combination thereof.

14: The method of claim 11, wherein the textile cleaning composition further comprises a defoaming agent according to the formula: 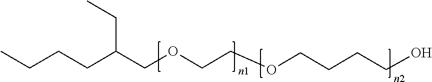
wherein n₁ is an integer of between 1-2 and n₂ is an integer of between 1-2.

15: The method of claim 14, wherein the defoaming agent is present in the textile cleaning composition in an amount of from about 1 wt. % to about 10 wt. %.

16: The method of claim 11, wherein the textile cleaning composition comprises between about 20 wt. % to about 50 wt. % of the first alcohol ethoxylate, from about 10 wt. % to about 30 wt. % of the second alcohol ethoxylate, from about 5 wt. % to about 15 wt. % of the alcohol solvent, and from about 5 wt. % to about 15 wt. % of the glycol solvent.

17: The method of claim 11, wherein the contacting occurs during a wash cycle.

18: The method of claim 17, wherein the wash cycle comprises a pre-soak phase, a wash phase, a rinsing phase, a finishing phase, and an extraction phase.

19: The method of claim 11, wherein the soil is a greasy or oily soil.

20: The method of claim 11, wherein the textile is comprised of cotton, polyester, or a cotton/polyester blend.
